(19) United States
(12) Patent Application Publication
(10) Pub. No.: US 2006/0275812 A1
(43) Pub. Date: Dec. 7, 2006

(54) Assay for agonists and antagonists of ion channels and for regulators of genetic expression

(75) Inventors: Darren P. Wolfe, Verona, PA (US); Joseph C. Glorioso, Fox Chapel, PA (US); Rahul Srinivasan, Pittsburgh, PA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: University of Pittsburgh of the Commonwealth System of Higher Education, Pittsburgh, PA (US)

(21) Appl. No.: 11/445,835

(22) Filed: Jun. 1, 2006

Related U.S. Application Data
(60) Provisional application No. 60/686,166, filed on Jun. 1, 2005.
(60) Provisional application No. 60/686,845, filed on Jun. 2, 2005.

(51) Int. Cl. C40B 30/06; C40B 40/08

(52) U.S. Cl. 435/6; 435/7.1

(57) ABSTRACT

The invention provides an assay for agonists and antagonists of ion channels and for regulators of genetic expression.

### CROSS-REFERENCE TO RELATED APPLICATIONS

This patent application claims the benefit of U.S. Provisional Patent Application No. 60/686,166, filed Jun. 1, 2005. This patent application also claims the benefit of U.S. Provisional Patent Application No. 60/686,845, filed Jun. 2, 2005. The contents of each of these prior applications are incorporated herein in their entirety.

### STATEMENT REGARDING FEDERALLY SPONSORED RESEARCH AND DEVELOPMENT

This invention was made in part with Government support under Grant Numbers NIH #5 U01HLO66949-05, 1U54 AI050733-01, and NIH R01 DK 54171 awarded by the United States National Institutes of Health. The Government of the Untied States of America may have certain rights in this invention

### BACKGROUND OF THE INVENTION

The human genome expresses over 400 ion channels involved in almost every vital biological process including cardiac, renal and nervous system functions (Hubner and Jentsch, 2002). Ion channel inhibition is consequently gaining importance as an approach to treat many disorders. Ion channel antagonists such as lidocaine (sodium channel antagonist) to treat neuropathic pain, the anti-convulsant levetiracetam (N-type calcium channel blocker), the anti-arrhythmic carvedilol (L-type calcium channel blocker), anti-cancer agents like carboxyamidotriazole (nonvoltage-operated calcium channel inhibitor), the anti-emetic ondansetron and numerous others are either established drugs or currently undergoing clinical trials (Cheng et al., 2001; Dutcher et al., 2005; Kalso, 2005; Lipton, 2004; Reis et al., 2004; Ye et al., 2001). The need for accelerated drug discovery has therefore resulted in high throughput screening (HTS) assays for ion channel antagonists (Zheng et al., 2004). Indeed, HTS assays identifying NMDA, AMPA and TRPV1 specific antagonists have been recently published (Bednar et al., 2004; Gunthorpe et al., 2004; Nikam and Kornberg, 2001).

Current fluorescence based HTS assays for antagonists generally rely on a loss of signal following channel activation (Gunthorpe et al., 2004). This strategy results in significant numbers of false positives due to non-specific effects, transient signals or signal quenching by the candidate compound (Grant et al., 2001; Jager et al., 2003). As a result, subsequent secondary stage compound analyses increase both time and labor requirements. Other HTS assay drawbacks include the use of expensive reagents (e.g. in fluorescence based assays), low throughput (e.g. patch clamping) or low expression levels (e.g. stably transfected cell based assays). Specifically, assays utilizing stably transfected cell lines for cDNA expression exhibit declining expression levels with continual in-vitro culture or when applied to HTS formats (Ames et al., 2004). This can cause ambiguity when interpreting assay results.

Identification of regulators of genetic expression (e.g., activators or inhibitors of promoters) is becoming increasingly important, particularly as the ability to differentiate stem cells into desired tissues evolves. Many genes, for example, are inactive in stem cells but become active during differentiation, presumably in response to the presence of genetic activators, or the absence of genetic inhibitors. The ability to turn on genes or turn off genes would be valuable for therapeutic as well as research purposes. However, identifying agents that can regulate the activity of given promoters is fraught with some of the same difficulties as the identification of agonists and antagonists of ion channels noted above.

Accordingly, there remains a need for a method of identifying agonists and antagonists of ion channels and for regulators of genetic expression.

### BRIEF SUMMARY OF THE INVENTION

The invention provides an assay for agonists and antagonists of ion channels and for regulators of genetic expression.

In one embodiment, the invention provides a method for identifying a candidate agonist agent of an ion channel. The method involves (a) constructing a replicating vector comprising a genome comprising an exogenous expression cassette encoding the ion channel, (b) introducing the vector into a cell able to complement the replication of the vector, (c) exposing the cell to a test agent, and (d) assaying the effect of the test agent on vector replication. A decrease in vector replication after exposure to the test agent is indicative that the test agent is a candidate agonist of an ion channel.

In a second embodiment, the invention provides a method for identifying a candidate antagonist agent of an ion channel. The method involves (a) constructing a replicating vector comprising a genome comprising an exogenous expression cassette encoding the ion channel, (b) introducing the vector into a cell able to complement the replication of the vector, (c) activating the ion channel so as to decrease vector replication, (d) exposing the cell to a test agent, and (e) assaying the effect of the test agent on vector replication. Rescued vector replication after exposure to the test agent is indicative that the test agent is a candidate antagonist of an ion channel.

In a third embodiment, the invention provides a method for identifying an inhibitor of a genetic promoter. The method comprises (a) constructing a replicating vector comprising a genome comprising the promoter in operable linkage to a nucleic acid encoding an ion channel, (b) introducing the vector into a cell able to complement the replication of the vector, (c) activating the ion channel so as to decrease vector replication, (d) exposing the cell to a test agent, and (e) assaying the effect of the test agent on vector replication. Rescued vector replication after exposure to the test agent is indicative that the test agent is a candidate inhibitor of the promoter.

In a fourth embodiment, the invention provides a method for identifying an activator of genetic expression. The method comprises (a) constructing a viral vector comprising a genome comprising the promoter in operable linkage to an essential viral gene, (b) introducing the vector into a cell able to complement the replication of the vector when the essential viral gene in operable linkage with the promoter is expressed but not able to complement the essential viral gene in operable linkage with the promoter in question, (c) exposing the cell to a test agent, and (d) assaying the effect of the test agent on viral replication. An increase in viral replication after exposure to the test agent is indicative that the test agent is a candidate activator of the promoter.

These advantages, and additional inventive features, will be apparent from the following description of the invention and the accompanying drawings.

### BRIEF DESCRIPTION OF THE DRAWINGS

FIG. 1A Genomic Representation of the Vectors vHG and vTT.

Both vectors contain deletions of the immediate early (IE) genes, ICP4 and ICP27. In the genome of vHG, an HCMV immediate early promoter driving enhanced green fluorescent protein (HCMVp:EGFP cassette) is inserted into both ICP4 loci. In the genome of the vTT vector a TKp:TRPV1 cassette coding for the rat TRPV1 receptor, driven by the TK early promoter (TKp:TRPV1) resides in the ICP4 loci.

FIG. 1B. Southern Blotting to Confirm Viral Genomic Structure. vHG, vTT and the plasmid pTT used in vTT construction. Viral DNA probed for; 1) the TRPV1 cDNA demonstrates that vHG is negative for TRPV1 cDNA. NcoI (1 kb and 0.8 kb bands) and SmaI (1.6 kb and 1 kb bands) cut TRPV1 internally. The NcoI digest has 4 kb and 6 kb bands indicative of two TRPV1 copies at the ICP4 loci, 2) using the TK promoter (TKp) as a probe confirms vHG and vTT are positive for endogenous TKp. The NcoI digest for vTT has two bands, indicating successful insertion of TKp at both ICP4 loci, 3) using the 5′ region of ICP4 demonstrates vHG and vTT display band shifts for BamH1 digests, confirming replacement of HCMVp:EGFP in vHG with TKp:TRPV1 in vTT at ICP4 loci, 4) Probing for ICP27 flanking sequences confirm identical deletions in vectors vTT and vHG.

FIG. 2. Protein Expression Profiles of Vectors vHG and vTT.

Complementing 7b and non-complementing Vero cell lines are shown for both viruses. ICP0 is expressed by both vectors in Vero cells by its natural IE gene promoter. EGFP is expressed only by vector vHG. TRPV1 expression is only from vector vTT and is limited to complementing 7b cells indicative of the E gene promoter used to mediate expression (all panels at 20× magnification).

FIG. 3. Functional Demonstration of TRPV1 Activation by Capsaicin.

vHG infected 7b cells do not respond to capsaicin (CAPS) stimulation (upper trace). vTT infected 7b cells show a large inward current (9 nA) following stimulation with 0.5 μM capsaicin (CAPS) (lower trace). Addition of PDBu (5 μM) following the first rapid phase of desensitization did not affect the current. Addition of the TRPV1 antagonist, ruthenium red (RuR-5 μM) brought the current back to baseline.

FIG. 4. Demonstration of Calcium Influx through TRPV1.

Intracellular calcium concentrations (Cai, nM) graphed against time (sec) in response to stimulation with 3 (FIG. 4A; 4B) or 0.3 μm (FIG. 4C; 4D) capsaicin (CAP), 5 μM ionomycin (IONO) and 10 mM EGTA are shown for vTT and QOZ infected cells.

FIG. 5. Demonstration of Cellular Apoptosis.

(A) vTT infected 7b complementing cells without capsaicin. (B) Bright field image of vTT infected 7b complementing cells incubated with 3 μm capsaicin for 60 min and (C) Fluorescent image of the same cells loaded with DePsipher dye to detect MPT. (D) Bright field image of vHG (control) infected 7b complementing cells incubated with 3 μm capsaicin (all images at 20× magnification, enlarged images are at 40× magnification).

FIG. 6. Effect of Capsaicin on vTT Viral Growth.

7b complementing cells were infected with vTT or vHG (control) virus. Infected cells were plated in culture media containing increasing doses of capsaicin (0 to 40 μM final). Viral titers determined from supernatant media at 24, 48 and 72 hours post-infection (hpi) are plotted against capsaicin concentration. Growth ratios, calculated as the ratio of vHG to vTT viral titers at each concentration of capsaicin are shown for each graph. (p<0.05, n=4)

FIG. 7. Effect of Resiniferatoxin (RTX) on vTT Viral Growth.

Complementing cells infected with vTT or vHG (control) virus were plated in culture media containing increasing doses of RTX (0 to 1000 nM final). Viral titers determined from supernatant samples are plotted against the RTX concentration at 24, 48 and 72 hours post-infection. Growth ratios for each concentration of RTX are indicated (top). (* p<0.05, n=4)

FIG. 8. Antagonism of TRPV1.

(A) vTT infected 7B cells (0.01 PFU/cell) are represented as growth curves at 24, 48 and 72 hours post-infection (hpi), after separate incubation with either nothing (NIL), 3 μM capsaicin (CAP), 5 μM Ruthenium Red (RuR), or 5 μM ruthenium red+3 μM capsaicin (RuR+CAP). (B) SB-366791 antagonism of TRPV1. Titers from vTT infected 7B cells are represented as growth curves at 24, 48 and 72 hours post-infection (hpi), after separate incubation with nothing (NIL), 3 μM capsaicin (CAP), 1 μM SB-366791 (SB1), 10 μM SB-366791 (SB10), 1 μM SB-366791+0.5 μM capsaicin (SB1+CAP) and 10 μM SB-366791+0.5 μM capsaicin (SB 10+CAP).

FIG. 9. Capsaicin Selection Sensitivity.

Mixed infections on 7B cells at indicated ratios of vHG:vTT viruses were passaged with 3 μM capsaicin (1st Pass), harvested and titered at 72 hours post-infection (72 hpi). Harvests from 1st passage were passaged a second time (2nd Pass) with 3 μM capsaicin, harvested at 72 hpi and titered. The relative output of vHG was quantified and is presented as percent output (vHG %).

### DETAILED DESCRIPTION OF THE INVENTION

The invention provides a vector based assay system utilizing selective vector replication as a read-out of ion channel inactivation or modulation of a genetic promoter. In all aspects, the inventive method involves a replicating vector to introduce a nucleic acid sequence into suitable cell types. The vector can be any type of vector able to replicate in the host cells, such as certain plasmid systems and viruses. Viruses are preferred for use in the inventive method, as viral replication can be assayed by screening for the formation of plaques or colonies indicative of productive viral infection of cells. For example, adenoviral and adeno-associated viral vectors can be used in the methods and compositions of the present invention. Construction of such vectors is known to those of ordinary skill in the art (see, e.g., U.S. Pat. Nos. 4,797,368, 5,691,176, 5,693,531, 5,880,102, 6,210,393, 6,268,213, 6,303,362, and 7,045,344).

A preferred vector system for use in the inventive method is an HSV vector system. Methods of engineering HVS vectors suitable for use in the inventive method are known to those of ordinary skill in the art. Some such methods and HSV-based vectors are described in, for example, U.S. Pat. Nos. 5,837,532, 5,846,782, and 5,804,413, and International Patent Applications WO 91/02788, WO 96/04394, WO 98/15637, and WO 99/06583, which are incorporated herein by reference. The sequence of HSV is available on the internet at www. ncbi.nlm.nih.gov:80/entrez/query.fcgi?cmd=Retrieve&db=nucleotide&list_uids=9629378&d opt=GenBank&term=hsv-1&qty=1, which may facilitate the generation of desired mutations in designing vectors.

In a preferred embodiment, a viral vector is deficient in at least one essential gene required for viral replication. For example, the HSV vector may be deficient in an immediate early gene selected from the group consisting of: ICP4, ICP22, ICP27, ICP47, and a combination thereof. An adenoviral vector preferably is deficient in a function provided by early region 1 (E1), which includes early region 1A (E1A) and early region 1B (E1B), and/or one or more functions encoded by early region 2 (E2), such as early region 2A (E2A) and early region 2B (E2B), and/or early region 3 (E3), and/or early region 4 (E4) of the adenoviral genome (See, e.g., U.S. Pat. Nos. 5,880,102, 6,482,616). Of course, the vector can alternatively or in addition be deleted for non-essential genes. Where an HSV vector is employed, preferably, it is “multiply deficient,” meaning that the vector is deficient in more than one gene function required for viral replication. One method of constructing multiply-deficient HSV vectors is to co-infect host cells with HSV vectors containing the desired gene deficiencies so that a resultant virus is produced having all of the desired deficiencies as a result of homologous recombination.

In embodiments in which the assay is employed to screen for agonists or antagonists of an ion channel, the vector is constructed to that an expression cassette encoding the ion channel is introduced into the vector genome. The expression cassette includes a DNA sequence encoding the ion channel and a suitable promoter. The promoter can be native to the vector genome (in which instance, the DNA sequence encoding the ion channel can be cloned into the vector genome to replace the native gene) or exogenous to the vector genome. The location of the cassette insertion into the vector genome is not critical to the method. Thus, the expression cassette can be inserted into an essential or nonessential locus of the vector genome.

In embodiments in which the assay is employed to screen for activators of promoter activity, preferably a viral vector is used. Such a vector is constructed so that the promoter being tested is engineered into the vector backbone such that it controls production of an essential viral gene. Thus, for example, where an HSV vector is employed, the promoter to be tested (i.e., the promoter-in-question) can be cloned into the HSV genome so as to replace the native HSV ICP4 promoters. In embodiments in which the assay is employed to screen for inhibitors of promoter activity, the vector is constructed so that the promoter-in-question is engineered into the vector backbone such that it controls production of an ion channel (such as those described herein).

The assay methods of the present invention involve introducing the vector into a cell able to complement the replication of the vector. In embodiments in which the assay is employed to screen for agonists or antagonists of ion channels, a viral or nonviral vector can be replication competent, in which instance the host cell need not express any complementing gene products from its own genome. More typically when viral vectors are employed, the vector is deficient for one or more essential genes, and in such applications of the inventive method, the host cell should independently produce proteins able to complement the functions of the gene products for which the vector is deficient. For example, where an HSV vector lacks functioning ICP4 genes, the host cell can be a cell that produces HSV ICP4. A noted above, a viral vector can be multiply-deficient (for example, an HSV vector can be ICP4-and ICP27-), in which instance, the host cell should complement all missing essential HSV gene products (e.g., both HSV ICP4 and ICP27 if an HSV viral vector is both ICP4- and ICP27-).

The host cell system can be of any type able to complement the vector as described herein. Thus, the host cell system can be derived from a type of cell commonly used to propagate vectors (e.g., Vero cells). For embodiments in which the inventive method is employed to assay for activators or inhibitors of genetic expression, the host cell system alternatively can be a stem cell line (e.g., an embryonic, hemopoetic, mesenchymal, etc. stem cell line). The use of such undifferentiated cells can allow the assay of promoters that may become activated in more differentiated cells, but which are inactive in stem cells. Alternatively, the host cell system can be differentiated cells or an existing cell line (such as HepG2, NT2, PC3, and the like). A particular cell line can be selected, for example, to have the components that make the promoter-in-question active. For example, where a promoter-in-question is one in which is active in a prostate cell, a suitable cell line expressing prostate genes (e.g., PC3) can be employed as the host cell system. Thus the cell line can be derived from any tissue type (e.g., neural, glial, dermal, stromal, adipose, muscle, endothelial, mesenchymal, gastrointestinal (e.g., gastric, intestinal, esophageal), glandular, (e.g., thyroid, adrenal, testicular, ovarian, parathyroid), hepatic, pancreatic, renal, cardiac, bone, cancerous, etc.), the regulation of genetic expression in which is of interest.

In accordance with the inventive method, the cells into which the vectors have been introduced are exposed to a test agent. The “test agent” can be any agent, the effect of which in agonizing/antagonizing an ion channel or in regulating a genetic promoter is desired to be assayed. Typically, the test agent is a small molecule, a peptide or a polynucleotide, but the agent also can be an environmental factor (e.g., temperature). In one embodiment the test agent is a polynucleotide and is introduced into the cell. The polynucleotide can be, for example, a cDNA encoding a polypeptide that is transcribed within the cell. Alternatively, the polynucleotide can be an siRNA or a ribozyme or a cDNA that encodes an siRNA or a ribozyme.

To assay for ion channel agonists or antagonists, the inventive method is predicated on vector expression of an ion channel, which on activation reduces vector replication following intracellular ion (e.g., Ca⁺²) overload. Without wishing to be bound by theory, it is believed that intracellular ion overload opens mitochondrial transition pores, leading to caspase activation and the initiation of an apoptotic cascade within the infected cell. As a consequence, vector growth is severely inhibited in cells able to support replication (e.g., complementing cells). The inventive assay system thus relies on the ability of an ion channel expression vector to replicate in the presence of channel antagonists.

To assay for an agonist of a candidate agonist of the ion channel, the method involves exposing the host cell to a test agent and assaying for the effect of the test agent on vector replication within the host cell. A decrease in vector replication after exposure to the test agent is indicative that the test agent is a candidate agonist of the ion channel. Preferably, the assay is performed relative to an untreated control (or to a sham control), so that false positive results are less likely. Also, preferably, a known antagonist (which can be a compound or environmental conditions, such as temperature) of the ion channel is further employed to assess whether the antagonist can reverse the ability of the test compound to decrease replication (e.g., to assess whether the known antagonist can rescue vector replication within the host cells even upon exposure to the test compound). If a known antagonist of the ion channel is able to rescue vector replication, a conclusion that the test compound is an agonist of the ion channel is even more likely.

The method employs similar steps for identifying antagonists of the ion channel. The complementing cells infected with the vector are treated to as to activate the ion channel. In some embodiments, the ion channel may be active constitutively within the host cell system. In other embodiments, the host cells are exposed to a known agonist of the ion channel (which can be a compound or environmental conditions, such as temperature) so as to decrease vector replication within the host cells. Thereafter (or in a parallel culture), the cells are exposed to a test agent and assayed to determine the effect of the test agent on vector replication. The ability of the test agent to rescue vector activation, even upon exposure to the known agonist, is indicative that the test agent is a candidate antagonist of an ion channel.

The assay for agonist and/or antagonists of ion channels can be used for any desired ion channel. The gene sequences of many ion channels are known, which will facilitate engineering vectors as herein described for expressing a desired channel in host cells. Moreover, agonists and antagonists of such channels also are known, which will facilitate ascertaining whether, in performance of the assays, vector replication can be reduced or rescued. A non-limiting list of exemplary ion channels, including an indication of their biological sequences, agonists, and antagonists is set forth in Table A:

TABLE A

| | GenBank | | |
|---|---|---|---|
| Channel | accession | | |
| name | number | Agonists | Antagonists |
| TRPV1 | NM_018727, | Capsaicin, | Ruthenium red, |
| | NM_080704, | protons, heat | capsazepine, SB- |
| | NM_080705, | (>42° C.), | 366791 |
| | NM_080706 | resiniferatoxin, | |
| | | anandamide, | |
| | | NADA, ETOH | |
| TRPV2 | NM_016113 | Growth factors | Ruthenium red |
| | | (mouse), heat | |
| | | (>52° C.) | |
| TRPV3 | NM_145068 | Camphor, 2- | Ruthenium red |
| | | APB, warmth | |
| | | (>33° C.) | |
| TRPV4 | NM_021625 | Hypotonic | Ruthenium red, |
| | | solution, phorbol | gadolinium |
| | | esters, warmth | |
| | | (27° C. to 42° C.) | |
| TRPM8 | NM_024080 | Menthol, icilin, | Capsazepine |
| | | eucalyptol, cold | |
| | | (<25° C.) | |
| TRPA1 | NM_007332 | Cinnamaldehyde, | Ruthenium red, |
| | | mustard oil, | camphor |
| | | allicin, icilin | |
| P2RX3 | NM_002559 | ATP, warmth | P1, P5-Di[inosine-5′] |
| | | | Pentaphosphate |
| | | | (IP5I) |
| ASIC | NM_001095 | Acidic pH, cold | Amiloride |
| Naᵥ1.3 | NM_013119 | Tetrodotoxin | Alpha- |
| | | | hydroxyphenylamide, |
| | | | phenytoin |
| Naᵥ1.7 | NM_002977 | Tetrodotoxin | Alpha- |
| | | | hydroxyphenylamide, |
| | | | phenytoin |
| Naᵥ1.8 | NM_006514 | PGE₂, adenosine, | μ-conotoxin |
| (PN3) | | serotonin | (SmIIIA) |
| Naᵥ1.9 | NM_014139 | Saxitoxin | Phenytoin |

To assay for activators of a gene promoter, the inventive method is predicated on non-complementation of an essential gene when the promoter is inactive. As noted herein, the promoter under study is linked to a vector gene that that host cell system is unable to complement. Thus, in the absence of activity of the promoter in operable linkage to the non-complemented essential gene, vector replication within the host cell system is profoundly reduced or eliminated. Thus, in accordance with the inventive method, the host cell system into which the vector is introduced is exposed to a test agent (which can be a protein, a small molecule, an environmental condition such as temperature, a genetic construct, etc.). Thereafter, the cell system is assayed to determine the effect of the test agent on vector replication in the test system. If vector replication is increased as a result of exposure of the host cell system to the test agent, then the test agent is a candidate activator of the promoter-in-question. Preferably, the assay is performed relative to an untreated control (or to a sham control), so that false positive results are less likely.

To assay for inhibitors of a gene promoter, the inventive method involves infecting a host cell system with a vector comprising an expression cassette in which the promoter-in-question is operably linked to a DNA encoding an ion channel. In accordance with the inventive method, in some embodiments, the ion channel may be active constitutively within the host cell system. In other embodiments, the host cells are exposed to a known agonist of the ion channel (which can be a compound or environmental conditions, such as temperature) so as to decrease vector replication within the host cells. For example, promoter/agonist pairs selected from table A can be employed in this assay (e.g., TRPV1/capsaicin). Thereafter (or in a parallel culture), the cells are exposed to a test agent and assayed to determine the effect of the test agent on vector replication. The ability of the test agent to rescue vector activation, even upon exposure to the known agonist, is indicative that the test agent is a candidate inhibitor of the promoter. The assay can be conducted in parallel with a control, in which a host cell system is infected with a vector comprising an expression cassette in which the coding sequence for the same ion channel is placed under the control of a different promoter, so as to reduce the likelihood that the result of the inventive method involves antagonism of the ion channel.

Similarly, the inventive method for identifying inhibitors of a gene promoter can be employed using an HSV vector having a construct linking the HSV tk coding sequence to the promoter in question and exposing the cells to ganciclvir (which inhibits tk and reduces or eliminates viral replication). The ability of the test agent to rescue viral replication in the presence of ganciclovir is indicative that the test agent is a candidate inhibitor of the promoter.

While the inventive method for identifying activators or inhibitors of genetic promoters can be employed for any promoter-of-interest, non-limiting examples of promoters that can be assayed in accordance with the inventive method are indicated in table B:

TABLE B

| Activation targets | |
|---|---|
| PAX3 | Promote Muscle Differentiation |
| LIF1 | Promote Stem Cell Pluripotency |
| Necdin | Promote GABAergic Neuron Differentiation |
| TH | Dopamine systhesis/ Parkinsons |
| LIM1 | Endoderm Differentiation/ Kidney Formation |
| Inhibition targets | |
| TERT | Promotes Tumorgenesis |
| VEGF | Promotes Blood vessel formation/ Tumor growth |
| APP | Alzheimer Plaque formation |

In performing the inventive assays, the effect of test compounds on vector replication is the read-out signal. It should be understood that the ability of a test agent to decrease vector replication need not be total for the test agent to be considered a candidate agonist or antagonist. Similarly, the ability of a compound to “rescue” vector replication need not be total (e.g., a compound can be said to rescue vector replication if it restores a measurable amount of replication).

Preferably, the inventive assay method is conducted in multiple iterations using a plurality of vectors and a plurality of host cells. The vectors within the plurality can be the same (e.g., clonal population) or different. Similarly, the cells within the plurality of host cells can be the same or different types of cells. Also, preferably where a plurality of vectors and host cells are employed, a plurality of test agents also can be employed. The several test agents can be pre-selected or comprise a random or semirandom library of diverse test agents. In this respect, the inventive method can be employed to screen a DNA, or RNA library for agents that are candidate ion channel agonists or antagonists. Typically, such a library will contain scores of different sequences. More preferably hundreds (at least 100) or even thousands (at least 1000 or at least 10000) of different expression cassettes differing in the sequence of DNAs constitute the library.

A preferred method for constructing such random or semirandom libraries employs the GATEWAY® system (Invitrogen). In the Gateway system, ccdB is used as a negative selectable marker that if present kills the bacteria cell. ccdB is replaced by a gene-of-interest, such as encoding a test compound to be assayed in accordance with the inventive method (or random DNA to generate a library) through site specific recombination carried out by a modified lambda integrase. Thus, the vector for use in the inventive method can have both the expression cassette comprising the promoter-of-interest and/or the ion channel-of interest and an expression cassette encoding the test compound.

Two relevant bacterial strains are used in Gateway technology, ccdB sensitive and ccdB resistant. The ccdB containing plasmid is propagated in ccdB resistant bacteria and purified. This plasmid is then used for in vitro recombination. The recombination product is transformed into a ccdB sensitive bacteria selecting for plasmids that have had the ccdB gene replaced by the gene-of-interest during the in vitro recombination. By replacing ccdB, the background in cloning and library construction is dramatically reduced or eliminated allowing the shuttling of genes into and out or a variety of plasmids at will. As a starting point the base plasmids must be grown in bacteria that are resistant to the toxic effects of ccdB of which there are a very limited number of genotypes available. Invitrogen markets a single ccdB resistant bacterial strain, but this strain does not accommodate large vectors (such as bacterial artificial chromosomes (“BACs”)) needed to accommodate larger viral vectors, such as HSV. Accordingly, to employ the GATEWAY® technology in the context of the invention using a large viral vector system, a bacterial strain amenable to transformation to large DNAs (such as BACs) desirably is modified to express a gene that confers insensitivity to ccdB. A preferred strain is derived from the DH10B bacterial strain used in BAC propagation and manipulation, which also has a mutation (fhuA::IS2) that increases their proclivity to transformation by very large DNAs.

For screening a library, preferably, the assay is conducted in parallel, typically in a multi-well culture system (e.g., 96 well plates), and an aliquot of the library vector is introduced in the respective wells at a calculated titer of less than 1 vector per well (typically about 0.5 vectors per well) to minimize the statistical likelihood that more than one vector will transfect or infect the cells. Thereafter, the respective wells are screened for vector replication as described herein. A similar multi-well approach can be employed for screening a plurality of test agents that are pre-selected, although where the plurality of test agents is pre-selected, the titer of such agents exposed to the respective cells is not as critical (in fact, differing titers/concentrations of the same substance or compound can constitute a plurality of test agents). Thus, whether through use of single test agents or pluralities of test agents, the inventive method can identify candidate ion channel agonist/antagonist or candidate genetic regulatory agents.

By “candidate” agonist/antagonist or regulatory agent is meant an agent that acts consistent with such role in the methods described herein. It is possible that a positive result in the inventive assay is an artifact due to a factor other than the promoter-in-question or the ion channel-in-question (e.g., a property peculiar to the host cell system). Thus, while the inventive method can identify candidate agonists/antagonists or regulatory agents, further testing in other systems can be employed to provide further evidence that the test agent is an agonist of an ion channel, an antagonist of an ion channel, or a regulator of gene expression.

As mentioned, the inventive method involves screening for enhanced or diminished vector replication. One manner of assessing replication where viral vectors are employed is to screen for the formation of plaques within the infected cultures. However, a high-throughput method of screening for viral replication is afforded when, in addition to the genetic construct comprising the promoter-of-interest and/or the ion channel, the genome of the vector for use in the inventive method further comprises an expression cassette encoding a biomarker (e.g., green fluorescent protein (GFP) or luciferase). In such embodiments, vector replication results in increased fluorescence that can be monitored using real-time robotic systems (e.g., FACS or flow-cytometry).

The following example further illustrates the invention but, of course, should not be construed as in any way limiting its scope.

### EXAMPLE 1

This example demonstrates the construction of a selectable assay system in which antagonism of an ion channel is assayed using viral replication as a read-out.

### Materials and Methods

Cell Culture.

The ICP4/ICP27 complementing cell line 7b (Marconi et al., 1996) was grown and maintained in Dulbecco's Minimum Essential Medium (DMEM) supplemented with 10% fetal bovine serum, 2 mM L-glutamine and 100 U/ml penicillin/streptomycin (all media components from Invitrogen). Cells were subcultured in 150 cm2 vented cap polystyrene tissue culture flasks (BD Falcon, Bedford, Mass.) and incubated at 37° C. in a humidified 5% CO₂ incubator. All reagents for TRPV1 selection studies (capsaicin, resiniferatoxin, ruthenium red and SB-366791) were obtained from Sigma (St. Louis, Mo.). Micromolar and nanomolar dilutions for experiments were made by serial dilutions of stock solutions and were added to media in the wells just prior to plating cells.

HSV-1 Vector Constructs.

The two vectors utilized throughout this study were vHG (vector HCMVp:EGFP) and vTT (vector TKp:TRPV1). vHG was engineered as follows: First, the QOZHG virus (ICP4-, ICP27-, βICP22, βICP47, βICP0p:LacZ::UL41, HCMVp:EGFP::ICP27) (Chen et al., 2000) which is derived from a cross of mutants TOZ.1 (Marconi et al., 1996) and d106 virus (Samaniego et al., 1998) was deleted for the EGFP expression cassette by homologous recombination with plasmid pPXE. pPXE contains a BamHI-SalI deletion of the UL54 (ICP27) coding sequence with a PmeI linker inserted between the BamHI and SalI sites (Niranjan et al., 2003). Second, the resultant virus, QOZ (ICP4-, ICP27-, βICP22, βICP47, ICP0p:LacZ::UL41), was then similarly deleted for the ICP0p:LacZ expression cassette present in the UL41 locus using plasmid p41 to make virus Q (ICP4-, ICP27-, βICP22, β47). Third, an HCMV immediate early (IE) promoter driving enhanced green fluorescent protein (EGFP) (HCMVp:EGFP) was engineered into the ICP4 locus between the AflIII-StyI (HSV bases 126413 to 131879) of the Q vector, to make vHG (ICP4-, ICP27-, βICP22, βICP47 HCMV:EGFP::ICP4) that has an expanded ICP4 deletion, truncated ICP22 and ICP47 promoters and contains two copies of the HCMV:EGFP expression cassette compared to the parental Q vector. The vTT vector (ICP4-, ICP27-, βICP22, βICP47, TKp:TRPV1::ICP4) was constructed by replacing the HCMVp:EGFP cassette in the ICP4 locus of vHG with a TRPV1 cDNA driven by the early HSV-1 TK promoter (TKp:TRPV1) using plasmid pTT. Plasmid pTT was constructed by inserting the PvuII-BglII fragment of pUX containing the early TK promoter and the Asp718-NotI fragment containing the rat TRPV1 coding sequence (Kind gift of D. Julius) (Caterina et al., 1997) into plasmid pSASB3. Plasmid pSASB3 contains the SphI-AflIII and StyI-EcoRII fragments flanking the ICP4 coding sequence with a unique BamHI linker inserted between the two fragments. To construct the recombinant vTT viruses, plasmids were recombined into the targeted locus of the parent virus vHG by sequential virus infection and plasmid transfection and screened for GFP negative plaques (Goins et al., 2002). Potential vTT vector plaques were purified by three rounds of limiting dilution and verified by Southern blot analysis. Confirmed virus stocks were expanded, titered on complementing cells, aliquoted and stored at −80° C.

Southern Blotting. vTT and vHG viral DNA extracted from 3×10⁶ 7b cells infected at 3 plaque forming units (PFU)/cell was used for Southern blotting. Southern blotting was performed using a North2South kit (Pierce, Rockford, Ill.) as per the manufacturer's instructions. Briefly, ˜lug viral DNA was digested with restriction enzymes and electrophoretically separated in a 1% agarose/TAE gel. Following overnight transfer to a nitrocellulose membrane, hybridization with biotinylated probe was carried out overnight at 55° C. The blot was then washed and developed with luminol. Gel images were detected by exposure to autoradiography film, developed, and scanned. A 10 Kb biotinylated lambda plus marker (New England Biolabs, Catalogue # N75545) was used as the molecular weight marker.

Immunocytochemistry.

For immunocytochemical analysis, complementing 7b cells were infected with either vHG or vTT (18 hpi, 0.3 PFU/cell). Following fixation in 4% formaldehyde at RT for 10 minutes, infected cells were washed twice with PBS, and then permeabilized in 0.001% Triton-X 100 for 10 minutes at RT. Slides were blocked with 10% horse serum in PBS for one hour at RT then incubated for one hour with either the TRPV1 (1:300, EMD Biosciences-Oncogene Research Products, LA Jolla, Calif.) or an ICP0 (1:500, raised in rabbits against the 30 C-terminal residues of the ICP0 protein) antibody. Slides were washed in PBS and incubated at RT for one hour with a TRITC labeled goat anti-rabbit IgG secondary antibody (1:500, Sigma, St Louis, Mo.). After washing with PBS, coverslips were applied and images captured using a Zeiss inverted fluorescent microscope with Axiovision software (Carl Zeiss Microimaging Inc., Thornwood, N.Y.).

Patch Clamping.

Gigaohm-seal whole-cell recordings of capsaicin induced currents were recorded in Vero cells infected with vTT, vHG (48 hpi, 10 PFU/cell) or uninfected cells using whole cell patch clamp techniques. Patch pipettes were pulled from capillary glass tubes (Accufil 90, Clay-Adams) and fire polished. Immediately before recording, the serum containing media was replaced with phosphate buffered saline. Whole cell currents were voltage clamped using an Axopatch 200A (Axon Instruments, Foster City, Calif.) amplifier. Pulse generation, current recording and data analysis used pClamp software (Axon Instruments). Currents were sampled at 500 μs, and filtered at 2 kHz. Capacitive currents and up to 80% of the series resistance were compensated. A p/4 protocol was used to subtract uncompensated capacitative currents and leak currents. The decay of TRPV1 currents in response to capsaicin and after addition of the phorbol ester, phorbol 12,13-dibutyrate (PDBu) or the PKC inhibitor bisindolylmaleimide I HCl (BIM) in the presence of capsaicin was fitted with single exponentials using pClamp software regression analysis. To determine the kinetics and voltage dependence of activation and inactivation of outward currents, a combined two pulse activation-inactivation protocol was used, consisting of series of rectangular pre-pulses from a holding potential of −90 mV. The pre-pulse, 1000 ms in duration, ranging from −140 to +90 mV was used to generate current activation. The inactivation curve was measured after a brief, 23 ms interpulse at −80 mV and a second test pulse to +60 mV, 250 ms in duration. Peak current amplitudes were measured with pClamp software.

The extracellular solution was Dulbecco phosphate buffer (Sigma, St. Louis, Mo.). The pipette (intracellular) solution contained (mM): KCl 120, K2HPO4 10, NaCl 10, MgCl₂ 2, EGTA 1, HEPES 10, pH adjusted to 7.4 with HCl. To this solution Mg-ATP (3 mM), cAMP (0.3 mM) and tris-GTP (0.5 mM) were added just prior to the experiments. Capsaicin (Calbiochem, San Diego, Calif.), a TRPV1 antagonist (Neurogen, Branford, Conn.), the phorbol ester, phorbol 12,13-dibutyrate (Research Biochemicals, Natcik, Mass.), and the PKC inhibitor bisindolylmaleimide I HCl (Calbiochem, San Diego, Calif.) were dissolved in DMSO (100 mM) and used at less than 0.01% of their stock concentration. At these dilutions, DMSO alone had no effect on TRPV1 responses to capsaicin. Ruthenium Red (RuR) was prepared in aqueous solutions. Stock solutions in 10-100 mM were stored at −20° C. and diluted in the external recording solution just before use. The TRPV1 antagonist (diaryl piperazine, NDT9515223) was a gift from Neurogen (Branford, Conn.) and was shown previously to be a potent and selective TRPV1 inhibitor (Ki=7 nM) (Sculptoreanu et al., 2005). Extracellularly applied drugs were pipetted from stock solutions at 10 to 100 times the final concentration and rapidly mixed in the recording chamber as described previously (Sculptoreanu and de Groat, 2003).

Intracellular Calcium Measurement.

Free intracellular calcium was measured by photon scanning on a dual excitation fluorimeter (PTI, Lawrenceville, N.J.). vTT or QOZ infected 7b cells were plated in 6 well plates containing 13.5×20 mm coverslips. Infected cells (8 hpi, 3 PFU/cell) were rinsed with 1× Hank's balanced salt solution (HBSS) and loaded with 2 μM FURA-2 (Molecular Probes Inc., Eugene, Oreg.) (Sneddon et al., 2000) for 1 hour at 37° C. in a 5% CO₂ incubator. Coverslips with FURA-2 loaded cells were then placed in a cuvette containing HBBS and then separately subjected to capsaicin at either 3 or 0.3 μM concentrations. Calcium flux following the application of each concentration of capsaicin was measured at 2 Hz and graphed. Results were calibrated by adding 5 μM ionomycin to obtain the maximum fluorescence ratio, followed by addition of 10 mM EGTA to obtain the minimum fluorescence ratio. A Kd of FURA-2 for calcium of 224 nM was assumed.

Detection of Apoptosis. The DePsipher kit (R&D systems, Minneapolis, Minn.) was used to detect the initiation of mitochondrial permeability transition (MPT) in 7b cells. Briefly, vTT or QOZ infected cells (12 hpi, 0.1 PFU/cell) were incubated with 3 μm capsaicin for one hour at 37° C. in a 5% CO₂ incubator. Cells were then loaded with 1 μl DePsipher/ml in pre-warmed culture media for 15-20 min at 37° C. in a 5% CO₂ incubator. Following two washes in prewarmed media, cells were immediately imaged using an inverted fluorescence microscope (Carl Zeiss Inc.). For activated caspase detection, the CaspACE FITC-VAD-FMK In-Situ Marker kit (Promega, Madison, Wis.) was used. Briefly, CaspACE FITC-VAD-FMK was added to a final concentration of 10 μM to 7b cells infected with vTT or QOZ virus (12 hpi, 0.3 PFU/cell). Cells were incubated for 20 minutes at 37° C. in a 5% CO₂ incubator. Following two washes in PBS, cells were fixed for 30 minutes in 10% formalin, washed three times with PBS and imaged using an inverted fluorescence microscope (Carl Zeiss Inc.).

Viral Growth Assay.

Infections for all TRPV1 functional studies were conducted in suspension in 15 ml conical tubes (Falcon) with DMEM media containing 10% FBS, and rocked on a nutator platform (Becton Dickinson, San Diego, Calif.) for 1 hour at 37° C. Cells were pelleted by centrifugation at 1000 rpm for 5 min and resuspended in 1 ml of fresh DMEM. 250,000 cells per well were plated in 24 well plates containing required final concentrations of reagents in 1 ml of DMEM with 10% FBS, and incubated at 37° C. in a humidified 5% CO₂ incubator. Supernatant samples collected at 24, 48 and 72 hrs post-infection (hpi) were titered by a standard viral plaque assay (Goins et al., 2002). The number of plaques for each viral dilution was counted and titers were expressed as viral plaque forming units (PFU) per ml of viral suspension.

Statistics.

For patch clamp experiments, results are reported as mean±SEM. Graphs for functional assays are based on data from four independent experiments (n=4). Error bars for all graphs are calculated as standard deviations. Statistical analysis for p values used t-test, 2 tail, and unequal variance. Data were considered to be statistically significant if p<0.05. Representative images for immunostaining and apoptosis experiments are shown following multiple iterations of each experiment.

### RESULTS

Vector Constructs and Southern Blotting.

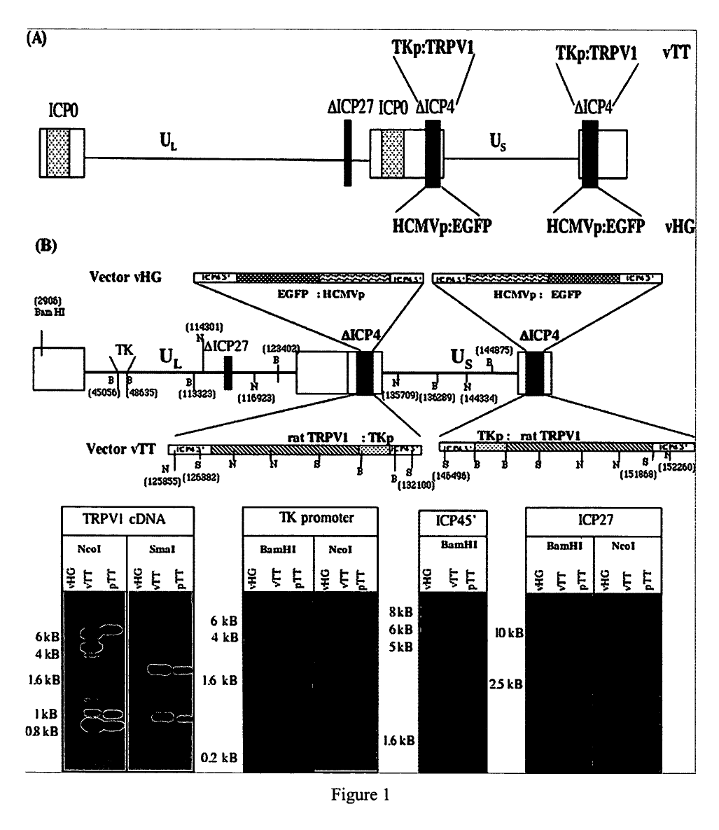

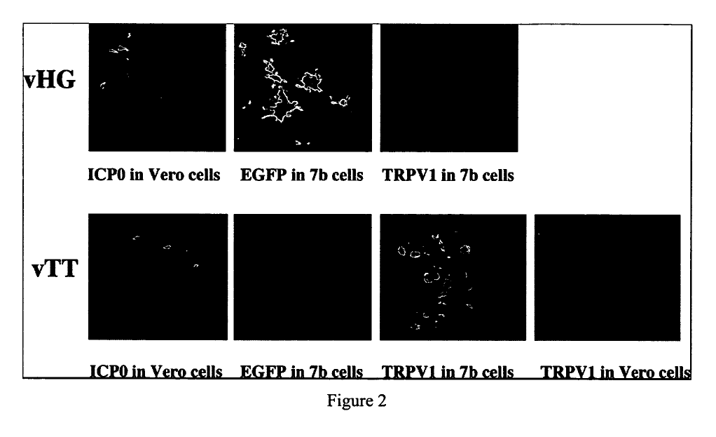

To carry out these studies, two HSV vectors were created: a test vector (vTT) containing the TRPV1 gene replacing both copies of the essential immediate early (IE) gene ICP4 and a control vector (vHG) in which the ICP4 gene was replaced by an EGFP reporter gene cassette (depicted in FIG. 1A). The recombinant vector backbone is also deleted for the essential IE gene ICP27. Deletion of either ICP4 or ICP27 prevents subsequent expression of early or late viral genes and provides a platform for gene transfer. Vector propagation and studies of TRPV1 function expressed from the vector genome were carried out in a complementing cell line (7b cells) that supply the ICP4 and ICP27 gene products in trans. TRPV1 was expressed under control of the viral early (E) gene promoter (HSV thymidine kinase) and thus is not expressed in non-complementing cells. Expression of TRPV1 occurs in complementing cells since the virus is able to replicate and thus activate promoters with early (E) and late (L) kinetics. This engineered delay in expression of TRPV1 enhances virus replication since TRPV1 imparts some toxicity without activation. The EGFP gene was placed under control of the HCMV IE promoter that is expressed both in complementing and non-complementing cells and is used as a visual indicator of vector transduction. The virus structures were confirmed by Southern blot analysis (FIG. 1B). All DNA digests were separately hybridized to probes for ICP27 (BamH1 to Sac1 fragment), ICP4 5′ (BamH1 to BglII fragment), thymidine kinase promoter (TKp) (PvuII to BglII fragment) or TRPV1 (Asp7l8 to Not1 cDNA fragment). Results confirm the correct insertion of the TRPV1 cDNA (TRPV1 probe) replacing EGFP at both ICP4 loci of vHG in vTT (FIG. 1B). The TKp and ICP4 5′ probes confirm that TRPV1 cDNA is under transcriptional control of the viral early TK promoter at both ICP4 loci of vTT. Blots probed with the ICP27 validate the identical deletion of ICP27 in both vectors (FIG. 1B).

Immunostaining.

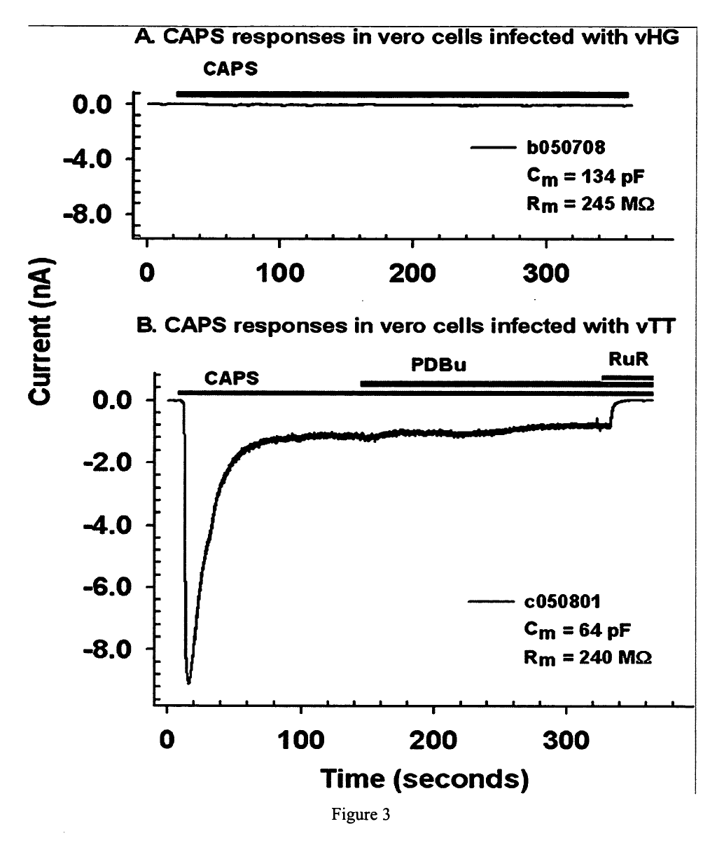

Expression of the individual transgenes from the vectors constructed above was confirmed prior to initiating functional experiments. Immunostaining for ICP0 in Vero cells at 18 hpi was positive for vHG and vTT viruses, confirming expression of ICP0 as an IE gene in both viral genomes as expected (FIG. 2). Complementing 7b cells infected with vTT were positive for TRPV1 receptor expression by immunofluoresence while the control vHG virus was negative indicating exclusive expression of TRPV1 from vTT. Non-complementing Vero cells infected with vTT were negative for TRPV1 at 18 hpi, confirming that TRPV1 driven by the TK early (E) promoter is active only during viral replication (FIG. 2). In 7b cells, the vHG virus harbors GFP+ plaques when viewed under fluorescence, while vTT plaquing is GFP−, indicative of successful marker transfer in these viruses (FIG. 2). Under high magnification (40×), positive TRPV1 staining localized to the cellular plasma membrane, cytoplasm and nuclear areas in vTT infected 7b cells.

Functional Demonstration of TRPV1 Activity.

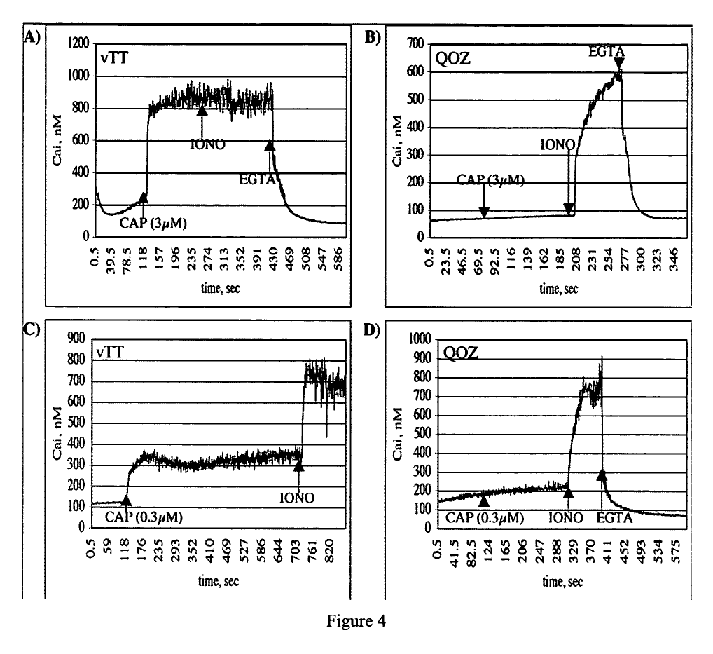

To demonstrate functional activity of the virally expressed TRPV1 receptor, whole cell electrophysiological recordings of vTT or vHG infected complementing 7b cells were conducted at 10, 24 or 48 hpi (10 PFU/cell). FIG. 3 shows a representative trace of electrophysiological recordings in vHG or vTT infected 7b cells. Control vHG infected 7b cells did not respond to capsaicin (FIG. 3). Capsaicin stimulation of vTT infected 7b cells resulted in large slowly desensitizing currents (˜5 to 9 nA range) at all post-infection time points tested. Following the initial phase of desensitization, the current could not be enhanced by application of the non-specific PKC activator PDBu. The known TRPV1 antagonists, ruthenium red (RuR) and diaryl piperazine (NDT9515223, Neurogen) antagonized the vTT specific currents. Table 1 summarizes electrophysiological recordings from vTT infected (n=8) and uninfected 7b cells (n=3). As seen in Table 1, pre-incubation of vTT infected 7b cells with bisindolylmaleimide (BIM), a PKC specific inhibitor resulted in significantly lower amplitude and rapidly desensitizing currents when compared to BIM untreated, vTT infected cells. These data demonstrate the functionality of virally expressed TRPV1 in complementing Vero cells.

Calcium Influx following TRPV1 Activation.

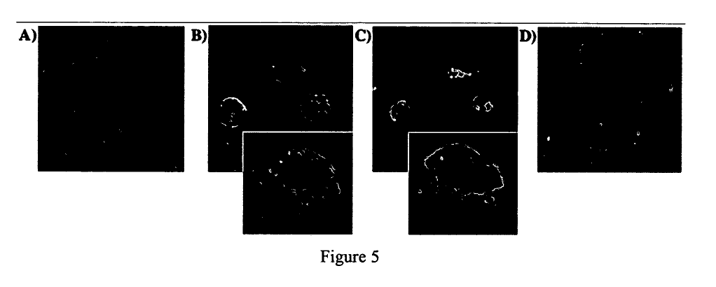

In order to demonstrate calcium influx through virally expressed TRPV1, the intracellular calcium level was monitored by FURA-2 loading after stimulation of vTT infected complementing cell lines with capsaicin. At 8 hpi, 3 μM capsaicin resulted in a significant increase of intracellular calcium in 7b cells infected with vTT virus (FIG. 4A). The response was sustained, maximal and did not further increase with 5 μM ionomycin. Addition of 10 mM EGTA caused the signal to return to baseline levels indicating functional TRPV1 located on the cell membrane. Sub-maximal concentration of capsaicin (0.3 μM) caused a smaller response than that observed with 3 μM capsaicin. This response was further increased after an addition of 5 μM ionomycin (FIG. 4B). Since GFP would interfere with FURA-2 measurements, the GFP negative virus, QOZ, was used as a negative control for intracellular Ca⁺² measurements and the demonstration of apoptosis. QOZ possesses a similar backbone to vHG, but lacks the HCMVp:EGFP cassette at the ICP4 loci but instead contains a ICP0p-LacZ cassette at the UL41 locus. QOZ infected cells displayed a maximal calcium influx in response to 5 μM ionomycin, but no effect with 0.3 or 3μM capsaicin (FIG. 4C, D).

Apoptosis Following Calcium Influx through Activated TRPV1.

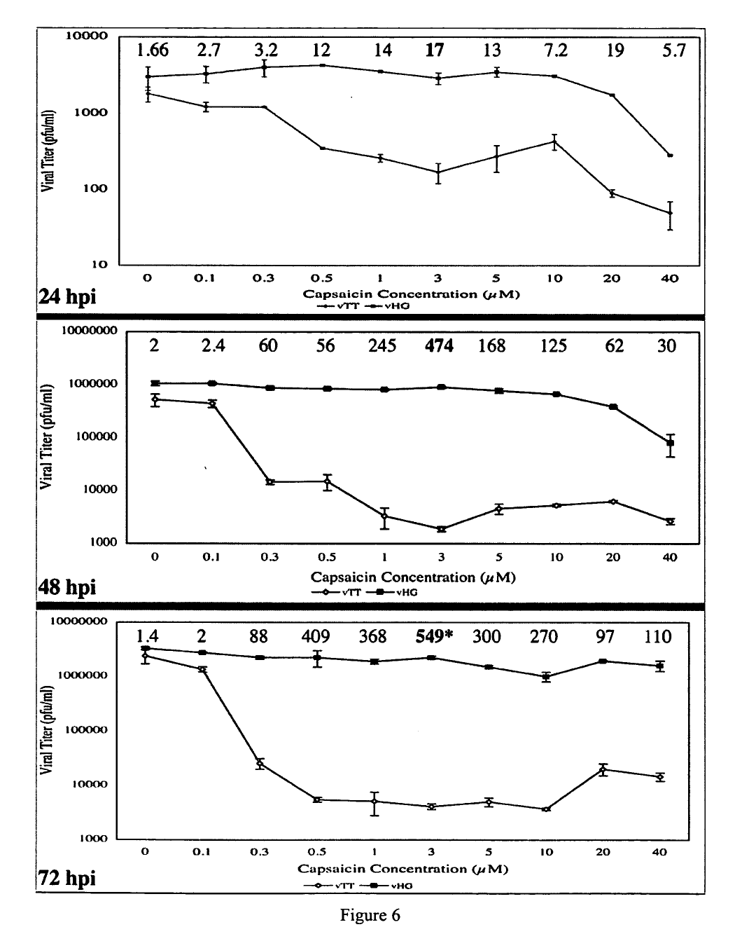

Mitochondrial permeability transition (MPT) is often the first change that occurs in apoptotic cascades and is a major component of TRPV1 activation induced apoptosis. Ca⁺² overload through activated TRPV1 has been specifically and uniquely linked to the development of MPT with subsequent activation of caspases (Jambrina et al., 2003) (Shin et al., 2003). In order to demonstrate the development of MPT due to intracellular calcium overload in our system, we assayed for MPT and caspase activation following capsaicin exposure in 7b cells transduced with vTT. MPT was specifically seen in vTT infected 7b cells at 12 hpi and not in QOZ infected 7b cells following 3 μM capsaicin stimulation for one hour (FIG. 5). In addition, vTT infected cells were positive for activated caspases following overnight capsaicin (3 μm) stimulation. QOZ infected cells did not display MPT when exposed to capsaicin. These data provide direct evidence for activated TRPV1 triggering Ca⁺² overload, leading to MPT and activation of the apoptotic cascade.

TRPV1 Activation Blocks Vector Replication.

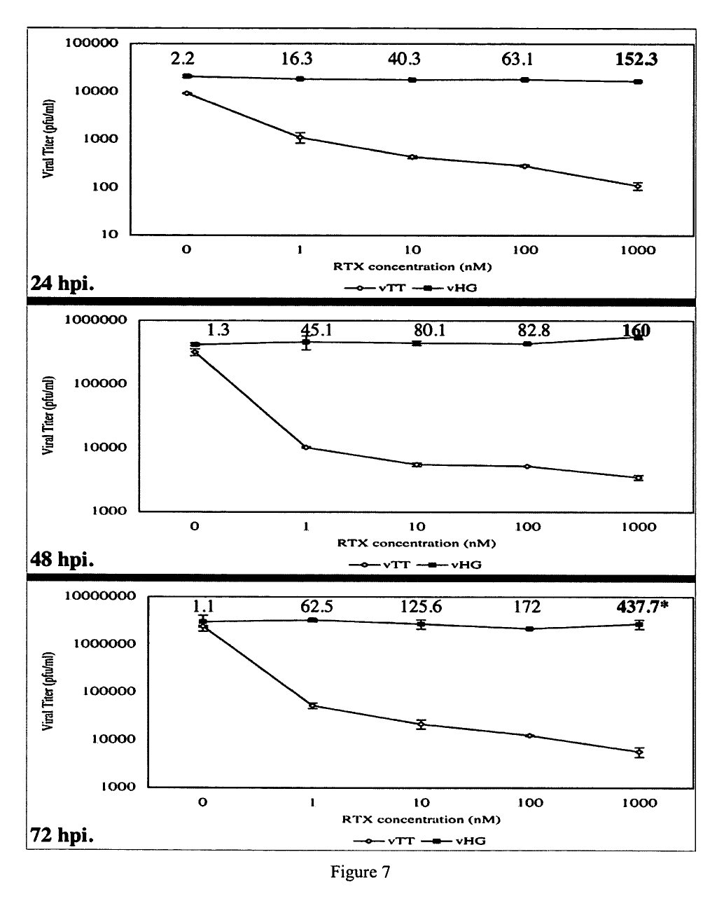

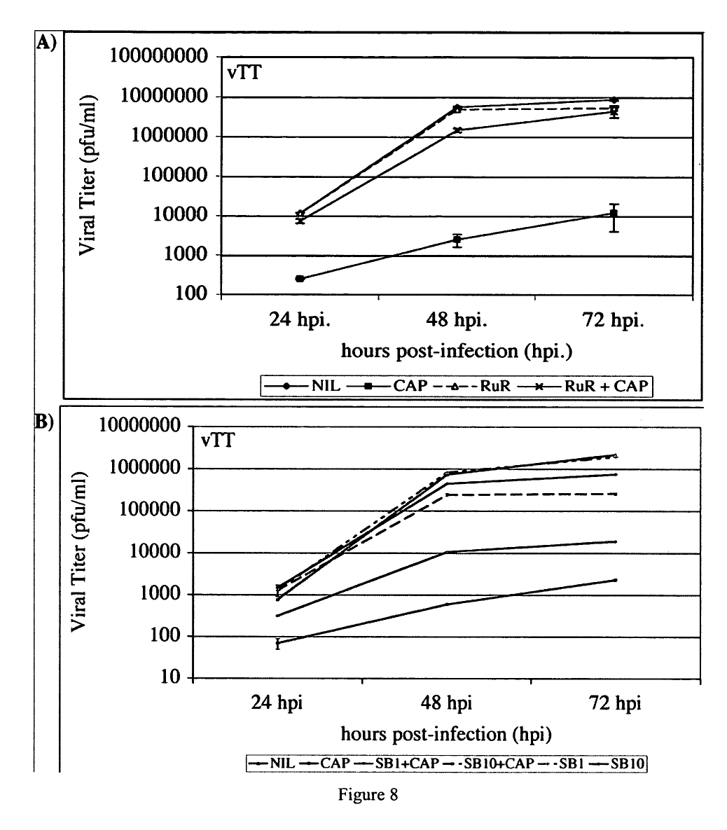

In the absence of TRPV1 agonists, vector vTT replicated slightly less robustly (˜0.1 log) than vHG at 24 and 48 hpi however, the final yield of these vectors was similar at 72 hpi. To quantify the effects of TRPV1 activation on viral replication, complementing 7b cells were infected at 0.01 PFU/cell and incubated in the presence of increasing concentrations (0.1 to 40 μM final) of the TRPV1 agonist capsaicin. To display the differences in replication between vHG (control) and vTT (TRPV1 expressing) vectors, the effect of capsaicin concentration over time on the ratio of vHG to vTT virus particle yield (growth ratio, GR) was determined. Significant differences in replication between vHG and vTT were observed at concentrations as low as 0.3 μM capsaicin (FIG. 6). The greatest GR differential (˜500 fold; p<0.05, n=4) was observed at 3 μM capsaicin concentration at 72 hpi (FIG. 6). In order to demonstrate the relative potency of selective replication using multiple TRPV1 agonists, the above experimental procedure was repeated with resiniferatoxin (RTX), an ultrapotent TRPV1 agonist. Nanomolar concentrations of RTX caused a reduction in vTT viral titers, similar to that seen with ˜100 fold higher doses of capsaicin at all time points. The highest observed difference in growth rate (GR=474; p<0.05, n=4) was seen with 1 μM RTX at 72 hpi (FIG. 7).

TRPV1 Antagonism Rescues Vector Replication.

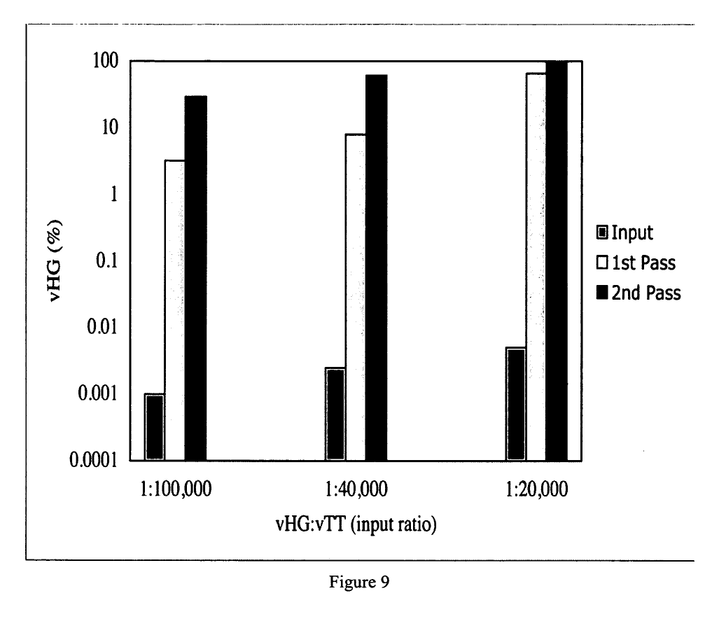

Viral yields were determined for infections in the presence of capsaicin alone or in cultures containing both capsaicin and known TRPV1 antagonists. To assess non-competitive antagonism of viral growth inhibition, ruthenium red (RuR), a known TRPV1 channel pore blocker was added to replication assays along with capsaicin (CAP). Vector infected 7b cells were plated in the presence of 3 μM CAP, 5 μM RuR, or 3 μM CAP+5 μM RuR and samples taken daily for viral titration. Vector replication was unaffected by 5 μM RuR alone at 24, 48 and 72 hours post infection. The presence of CAP specifically inhibited vTT replication without affecting vHG titers, as previously observed. In the presence of both 3 μM CAP and 5 μM RuR, replication of vTT was completely restored (p<0.05, n=4) (FIG. 8A). In order to demonstrate competitive antagonism of TRPV1 activation by capsaicin, similar assays using a known competitive capsaicin antagonist, SB-366791 (Gunthorpe et al., 2004) were conducted. Addition of SB-366791 alone (at 1 and 10 μM concentrations) did not affect replication of vHG or vTT (FIG. 8B). Addition of both CAP and SB-366791 did not affect replication of the control vector, vHG. A dose dependent rescue of viral titers with 1 μM and 10 μM SB-366791 in the presence of 0.5 μM capsaicin was observed at all time points post-infection (p<0.05, n=4) (FIG. 8B), demonstrating TRPV1 specific antagonism of CAP activation.

Selection Against vTT in Mixed Infections.

The vTT virus described in this study should prove useful in chemical selection assays to identify novel antagonists of TRPV1. With this in mind, and to determine the sensitivity of capsaicin based genetic selection against TRPV1 activation, mixed infections of 7b cells with varying ratios of vTT and vHG viruses were carried out with or without 3 μM capsaicin (0.4 PFU/cell). Cells were harvested at 72 hpi (after cytopathic effect) and titered. Plaques were then counted for each dilution of mixed vTT:vHG infections, and scored as a percentage of GFP+ (vHG) versus GFP− (vTT) plaques. Samples from the first passage were then re-passaged in complementing cells with or without 3 μM capsaicin (0.4 PFU/cell), followed by rescoring for GFP positive plaques. The results are presented in FIG. 9 as percent input versus percent output of fluorescent viral plaques. Starting with 0.005% vHG input (1:20,000 vHG:vTT), 66% after one passage and 95% vHG (GFP+) after two passages was observed in the presence of capsaicin (p<0.05, n=4) (FIG. 9), demonstrating a very effective selective pressure against TRPV1 in the presence of capsaicin. Starting with as little as 1:100,000 vHG, cultures containing significant proportions (40%) of vHG after two passages in capsaicin (FIG. 8) were found.

No obvious TRPV1 mutants in vTT were discovered during these experiments that could escape capsaicin stimulation even after serial passage in the presence of agonist. Replication of vTT is substantially suppressed by incubation with capsaicin and viral particles that are able to replicate remain sensitive to capsaicin. A second passage in the presence of capsaicin results in further selection for the TRPV1 negative and GFP+ control vector vHG.

The data from this study demonstrate the sensitivity of using a capsaicin-based chemical or genetic selection strategies to identify TRPV1 antagonsits. The assay system is applicable to other channels as well. Moreover, the assay can be used not only to identify chemical antagonists but also cDNA antagonists, antagonism by gene knockout (e.g., using RNAi) or to screen random peptide libraries for antagonists of ion channels.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

All references, including publications, patent applications, and patents, cited herein, including but not limited to those in the following list, are hereby incorporated by reference to the same extent as if each reference were individually and specifically indicated to be incorporated by reference and were set forth in its entirety herein.
Ames R, Fornwald J, Nuthulaganti P, Trill J, Foley J, Buckley P, Kost T, Wu Z and Romanos M (2004) BacMam recombinant baculoviruses in G protein-coupled receptor drug discovery. Receptors Channels 10(3-4):99-107.
Bednar B, Cunningham M E, Kiss L, Cheng G, McCauley J A, Liverton N J and Koblan K S (2004) Kinetic characterization of novel NR2B antagonists using fluorescence detection of calcium flux. J Neurosci Methods 137(2):247-255.
Bodo E, Biro T, Telek A, Czifra G, Griger Z, Toth B I, Mescalchin A, Ito T, Bettermann A, Kovacs L and Paus R (2005) A hot new twist to hair biology: involvement of vanilloid receptor-1 (VR1/TRPV1) signaling in human hair growth control. Am J Pathol 166(4):985-998.
Caterina M J, Leffler A, Malmberg A B, Martin W J, Trafton J, Petersen-Zeitz K R, Koltzenburg M, Basbaum A I and Julius D (2000) Impaired nociception and pain sensation in mice lacking the capsaicin receptor. Science 288(5464):306-313.
Caterina M J, Schumacher M A, Tominaga M, Rosen T A, Levine J D and Julius D (1997) The capsaicin receptor: a heat-activated ion channel in the pain pathway. Nature 389(6653):816-824.
Chen X, Li J, Mata M, Goss J, Wolfe D, Glorioso J C and Fink D J (2000) Herpes simplex virus type 1 ICP0 protein does not accumulate in the nucleus of primary neurons in culture. J Virol 74(21):10132-10141.
Cheng J H, Kamiya K and Kodama I (2001) Carvedilol and vesnarinone: new antiarrhythmic approach in heart failure therapy. Acta Pharmacol Sin 22(3):193-200. Cortright D N and Szallasi A (2004) Biochemical pharmacology of the vanilloid receptor TRPV1. An update. Eur J Biochem 271(10):1814-1819.
Cruz F (2004) Mechanisms involved in new therapies for overactive bladder. Urology 63(3 Suppl 1):65-73.
Dutcher J P, Leon L, Manola J, Friedland D M, Roth B and Wilding G (2005) Phase II study of carboxyamidotriazole in patients with advanced renal cell carcinoma refractory to immunotherapy: E4896, an Eastern Cooperative Oncology Group Study. Cancer 104(11):2392-9
El Kouhen R, Surowy C S, Bianchi B R, Neelands T R, McDonald H A, Niforatos W, Gomtsyan A, Lee C H, Honore P, Sullivan J P, Jarvis M F and Faltynek C R (2005) A-425619 [1-isoquinolin-5-yl-3-(4-trifluoromethyl-benzyl)-urea], a novel and selective transient receptor potential type V1 receptor antagonist, blocks channel activation by vanilloids, heat, and acid J Pharmacol Exp Ther 314(1):400-409.
Glorioso J C and Fink D J (2004) Herpes vector-mediated gene transfer in treatment of diseases of the nervous system. Annu Rev Microbiol 58:253-271.
Goins W F, Krisky D M, Wolfe D P, Fink D J and Glorioso J C (2002) Development of replication-defective herpes simplex virus vectors. Methods Mol Med 69:481-507.
Grant S K, Bansal A, Mitra A, Feighner S D, Dai G, Kaczorowski G J and Middleton R E (2001) Delay of intracellular calcium transients using a calcium chelator: application to high-throughput screening of the capsaicin receptor ion channel and G-protein-coupled receptors. Anal Biochem 294(1):27-35.
Gunthorpe M J, Rami H K, Jerman J C, Smart D, Gill C H, Soffin E M, Luis Hannan S, Lappin S C, Egerton J, Smith G D, Worby A, Howett L, Owen D, Nasir S, Davies C H, Thompson M, Wyman P A, Randall A D and Davis J B (2004) Identification and characterisation of SB-366791, a potent and selective vanilloid receptor (VR1/TRPV1) antagonist. Neuropharmacology 46(1):133-149.
Hong S and Wiley J W (2005) Early painful diabetic neuropathy is associated with differential changes in the expression and function of vanilloid receptor 1. J Biol Chem 280(1):618-627.
Hubner C A and Jentsch T J (2002) Ion channel diseases. Hum Mol Genet 11(20):2435-2445.
Jager S, Brand L and Eggeling C (2003) New fluorescence techniques for high-throughput drug discovery. Curr Pharm Biotechnol 4(6):463-476.
Jambrina E, Alonso R, Alcalde M, del Carmen Rodriguez M, Serrano A, Martinez A C, Garcia-Sancho J and Izquierdo M (2003) Calcium influx through receptor-operated channel induces mitochondria-triggered paraptotic cell death. J Biol Chem 278(16):14134-14145.
Kalso E (2005) Sodium channel blockers in neuropathic pain. Curr Pharm Des 11(23):3005-3011.
Lipton S A (2004) Failures and successes of NMDA receptor antagonists: molecular basis for the use of open-channel blockers like memantine in the treatment of acute and chronic neurologic insults. NeuroRx 1(1):101-110.
Marconi P, Krisky D, Oligino T, Poliani P L, Ramakrishnan R, Goins W F, Fink D J and Glorioso J C (1996) Replication-defective herpes simplex virus vectors for gene transfer in vivo. Proc Natl Acad Sci USA 93(21):11319-11320.
McGaraughty S, Chu K L, Faltynek C R and Jarvis M F (2006) Systemic And Site-Specific Effects Of A-425619, A Selective Trpv1 Receptor Antagonist, On Wide Dynamic Range Neurons In Cfa-Treated And Uninjured Rats. J Neurophysiol 95(1):18-25.
Nikam S S and Kornberg B E (2001) AMPA receptor antagonists. Curr Med Chem 8(2):155-170.
Niranjan A, Wolfe D, Tamura M, Soares M K, Krisky D M, Lunsford L D, Li S, Fellows-Mayle W, DeLuca N A, Cohen J B and Glorioso J C (2003) Treatment of rat gliosarcoma brain tumors by HSV-based multigene therapy combined with radiosurgery. Mol Ther 8(4):530-542.
Ramsey I S, Delling M and Clapham D E (2006) An Introduction to TRP Channels. Annu Rev Physiol 68:619-47.
Reis J, Wentrup A, Hamer H M, Mueller H H, Knake S, Tergau F, Oertel W H and Rosenow F (2004) Levetiracetam influences human motor cortex excitability mainly by modulation of ion channel function—a TMS study. Epilepsy Res 62(1):41-51.
Samaniego L A, Neiderhiser L and DeLuca N A (1998) Persistence and expression of the herpes simplex virus genome in the absence of immediate-early proteins. J Virol 72(4):3307-3320.
Sculptoreanu A and de Groat W C (2003) Protein kinase C is involved in neurokinin receptor modulation of N- and L-type Ca2+ channels in DRG neurons of the adult rat. J Neurophysiol 90(1):21-31.
Sculptoreanu A, de Groat W C, Buffington C A and Birder L A (2005) Protein kinase C contributes to abnormal capsaicin responses in DRG neurons from cats with feline interstitial cystitis. Neurosci Lett 381(1-2):42-46.
Shin C Y, Shin J, Kim B M, Wang M H, Jang J H, Surh Y J and Oh U (2003) Essential role of mitochondrial permeability transition in vanilloid receptor 1-dependent cell death of sensory neurons. Mol Cell Neurosci 24(1):57-68.
Smart D, Gunthorpe M J, Jerman J C, Nasir S, Gray J, Muir A I, Chambers J K, Randall A D and Davis J B (2000) The endogenous lipid anandamide is a full agonist at the human vanilloid receptor (hVR1). Br J Pharmacol 129(2):227-230.
Sneddon W B, Liu F, Gesek F A and Friedman P A (2000) Obligate mitogen-activated protein kinase activation in parathyroid hormone stimulation of calcium transport but not calcium signaling. Endocrinology 141(11):4185-4193.
Stavrovskaya I G and Kristal B S (2005) The powerhouse takes control of the cell: is the mitochondrial permeability transition a viable therapeutic target against neuronal dysfunction and death? Free Radic Biol Med 38(6):687-697.
Szabo A, Helyes Z, Sandor K, Bite A, Pinter E, Nemeth J, Banvolgyi A, Bolcskei K, Elekes K and Szolcsanyi J (2005) Role of transient receptor potential vanilloid 1 receptors in adjuvant-induced chronic arthritis: in vivo study using gene-deficient mice. J Pharmacol Exp Ther 314(1):111-119.
Tominaga M, Caterina M J, Malmberg A B, Rosen T A, Gilbert H, Skinner K, Raumann B E, Basbaum A I and Julius D (1998) The cloned capsaicin receptor integrates multiple pain-producing stimuli. Neuron 21(3):531-543.
Varga A, Nemeth J, Szabo A, McDougall J J, Zhang C, Elekes K, Pinter E, Szolcsanyi J and Helyes Z (2005) Effects of the novel TRPV1 receptor antagonist SB366791 in vitro and in vivo in the rat. Neurosci Lett 385(2):137-142.
Ye J H, Ponnudurai R and Schaefer R (2001) Ondansetron: a selective 5-HT(3) receptor antagonist and its applications in CNS-related disorders. CNS Drug Rev 7(2):199-213.
Zheng J, Dai C, Steyger P S, Kim Y, Vass Z, Ren T and Nuttall A L (2003) Vanilloid receptors in hearing: altered cochlear sensitivity by vanilloids and expression of TRPV1 in the organ of corti. J Neurophysiol 90(l):444-455.

Zheng W, Spencer R H and Kiss L (2004) High throughput assay technologies for ion channel drug discovery. Assay Drug Dev Technol 2(5):543-552.

TABLE 1
Electrophysiological parameters and capsaicin currents in HSV-1 infected and uninfected Vero cells.
Parameters of excitability and K⁺ currents were determined as explained in Methods and Results sections.
Peak outward current amplitudes are for currents generated at +60 mV.
The numbers of cells measured for each parameter are indicated in parenthesis.

| | | | | Outward | | Capsaicin |
|---|---|---|---|---|---|---|
| | Membrane | Membrane | Resting | Current | | Desensitization |
| | Capacitance | Resistance | Potential | Amplitude | Capsaicin | Time-course |
| Infection | Cₘ (pF) | Rₘ (MΩ) | RP (mV) | (nA) | (nA) | (tau, s) |
| vTT | 71.8 ± 7.6 | 207.3 ± 26.9 | 0.04 ± 0.04 | 0.5 ± 0.4 | −6.0 ± 0.6 | 280.6 ± 45.1 |
| | (10) | (10) | (5) | (3) | (8) | (8) |
| vTT | 56.5 ± 2.5 | 193.5 ± 76.5 | — | — | −2.2 ± 1.2 | 53.4 ± 15.4 |
| (BIM pre- | (3)^{NS} | (3)^{NS} | | | (3)** | (3)*** |
| incubation) | | | | | | |
| vHG | 171.5 ± 30.9 | 442.3 ± 109.8 | 0.8 ± 0.8 | 1.1 ± 0.1 | No | — |
| | (4) | (4) | (4) | (4) | Response | |
| no virus | 34.0 ± 7.5 | 357.0 ± 122.1 | −12.00 ± 2.8 | 0.7 ± 0.2 | No | — |
| | (3) | (3) | (2) | (3) | Response | |

Level of significance: ^{NS}=not significant, **= p < 001, or ***= p < 0.001; vTT = vector TKp: TRPV1; vHG = vector HCMVp: EGEP; BIM = PKC inhibitor, bisindolylmalcimide.

1. A method for identifying a candidate agonist agent of an ion channel, comprising:
(a) constructing a replicating vector comprising a genome comprising an exogenous expression cassette encoding the ion channel,
(b) introducing the vector into a cell able to complement the replication of the vector,
(c) exposing the cell to a test agent, and
(d) assaying the effect of the test agent on vector replication,
whereby a decrease in vector replication after exposure to the test agent is indicative that the test agent is a candidate agonist of an ion channel.

2. A method of identifying a candidate antagonist of an ion channel, comprising:
(a) constructing a replicating vector comprising a genome comprising an exogenous expression cassette encoding the ion channel,
(b) introducing the vector into a cell able to complement the replication of the vector,
(c) activating the ion channel so as to decrease vector replication,
(d) exposing the cell to a test agent, and
(e) assaying the effect of the test agent on vector replication,
whereby rescued vector replication after exposure to the test agent is indicative that the test agent is a candidate antagonist of an ion channel.

3. A method for identifying a candidate inhibitor of a promoter, comprising:
(a) constructing a replicating vector comprising a genome comprising the promoter in operable linkage to a nucleic acid encoding an ion channel,
(b) introducing the vector into a cell able to complement the replication of the vector,
(c) activating the ion channel so as to decrease vector replication,
(d) exposing the cell to a test agent, and
(e) assaying the effect of the test agent on vector replication;
whereby rescued vector replication after exposure to the test agent is indicative that the test agent is a candidate inhibitor of the promoter.

4. A method for identifying a candidate activator of a promoter, comprising:
(a) constructing a viral vector comprising a genome comprising the promoter in operable linkage to an essential viral gene,
(b) introducing the vector into a cell able to complement the replication of the vector when the essential viral gene in operable linkage with the promoter is expressed but which is unable to compliment the essential viral gene in operable linkage with the promoter,
(c) exposing the cell to a test agent, and
(d) assaying the effect of the test agent on viral replication,
whereby an increase in viral replication after exposure to the test agent is indicative that the test agent is a candidate activator of the promoter.

5. A method for identifying a candidate inhibitor of a promoter, comprising:
(a) constructing a herpes simplex virus (HSV) comprising a genome comprising the promoter in operable linkage to a nucleic acid encoding HSV tk,
(b) introducing the HSV into a cell able to complement the replication of the HSV,
(c) exposing the cell to ganciclovir so as to decrease viral replication,
(d) exposing the cell to a test agent, and
(e) assaying the effect of the test agent on viral replication;
whereby rescued viral replication after exposure to the test agent is indicative that the test agent is a candidate inhibitor of the promoter.

6. The method of any of claims 1-3, wherein the vector is a viral vector.

7. The method of any of claims 3-5, wherein the cell is a stem cell.

8. The method of any of claims 1-5, wherein the cell is a cell line.

9. The method of claim 8, wherein the cell line is HepG2, NT2, or PC3.

10. The method of any of claims 1-5, wherein the vector further comprises an expression cassette encoding a biomarker.

11. The method of any of claims 1-5, wherein the test agent is a small molecule, a peptide or a polynucleotide.

12. The method of claim 11, wherein the test agent is a polynucleotide and is introduced into the cell.

13. The method of claim 12, wherein the polynucleotide is a cDNA encoding a polypeptide that is transcribed within the cell.

14. The method of claim 12, wherein the polynucleotide is an siRNA or a ribozyme or a cDNA that encodes an siRNA or a ribozyme.

15. The method of any of claims 1-5, wherein the assay is conducted in multiple iterations using a plurality of vectors and a plurality of host cells.

16. The method of claim 15, further employing a plurality of test agents.

17. The method of claim 16, wherein the plurality of test agents define a library of random or semirandom agents.
